(19) United States
(12) Patent Application Publication
(10) Pub. No.: US 2026/0247239 A1
(43) Pub. Date: Aug. 20, 2026

(54) COMMUNICATION METHOD, ELECTRONIC DEVICE, AND STORAGE MEDIUM

(71) Applicant: BEIJING XIAOMI MOBILE SOFTWARE CO., LTD., Beijing (CN)

(72) Inventor: Xiandong DONG, Beijing (CN)

(73) Assignee: BEIJING XIAOMI MOBILE SOFTWARE CO., LTD., Beijing (CN)

(21) Appl. No.: 19/160,455

(22) PCT Filed: Feb. 28, 2023
(86) PCT No.: PCT/CN2023/078699

§ 371 Date: Aug. 27, 2025

(51) Int. Cl. H04W 36/08; H04L 5/00; H04W 36/00

(52) U.S. Cl. CPC H04W 36/08; H04L 5/0053; H04W 36/0061

(57) ABSTRACT

Embodiments of the present disclosure relate to the technical field of mobile communications, and provide a communication method, an electronic device, and a storage medium. The communication method is applicable to a station (STA), and the method includes: determining a first data frame, wherein the first data frame comprises first identification information, and the first identification information indicates that an STA request is switched from a first access point (AP) to a second AP, and the first identification information comprises first switching parameter information switched to the second AP; and sending the first data frame.

### CROSS-REFERENCE TO RELATED APPLICATION

The present application is a U.S. National Stage of International Application No. PCT/CN2023/078699 filed on Feb. 28, 2023, the entire content of which is incorporated herein by reference.

### TECHNICAL FIELD

The embodiments of the present disclosure relate to the technical field of mobile communication, and in particular, to a communication method, an electronic device, and a storage medium.

### BACKGROUND

Currently, research in Wi-Fi technology includes Ultra High Reliability (UHR), which aims to improve the reliability of Wireless Local Area Networks (WLAN) connections, reduce latency, enhance manageability, increase throughput at varying Signal to Noise Ratio (SNR) levels, and reduce device-level power consumption. Furthermore, in UHR, in order to increase system throughput, a mode for simultaneous communication in the sub7 GHz (gigahertz) and 45 GHz and/or 60 GHz bands is proposed.

In UHR, low-latency service transmission mechanisms will be further enhanced. To ensure low-latency service transmission, stations (STAs) may switch between multiple access points (APs). Therefore, a mechanism is needed to support STA switching between multiple APs to meet the transmission requirements of UHR.

### SUMMARY

Embodiments of the present disclosure provide a communication method, an electronic device, and a storage medium.

In one aspect, an embodiment of the present disclosure provides a communication method, applied to a station (STA), and the method includes:
determining a first data frame, where the first data frame includes first identification information, the first identification information identifies that the STA requests to switch from a first access point (AP) to a second AP, and the first identification information includes first switching parameter information for switching to the second AP; and
sending the first data frame.

In another aspect, an embodiment of the present disclosure further provides a communication method, applied to a first access point (AP), and the method includes:
receiving a first data frame, where the first data frame includes first identification information, the first identification information identifies that an STA requests to switch from the first AP to a second AP, and the first identification information includes first switching parameter information for switching to the second AP.

In another aspect, an embodiment of the present disclosure further provides an electronic device, where the electronic device is a station (STA), and the electronic device includes:
a first determining module, configured to determine a first data frame, where the first data frame includes first identification information, the first identification information identifies that the STA requests to switch from a first access point (AP) to a second AP, and the first identification information includes first switching parameter information for switching to the second AP; and
a first sending module, configured to send the first data frame.

In another aspect, an embodiment of the present disclosure further provides an electronic device, which is a first access point (AP), and includes:
a first receiving module, configured to receive a first data frame, where the first data frame includes first identification information, the first identification information identifies that an STA requests to switch from the first AP to a second AP, and the first identification information includes first switching parameter information for switching to the second AP.

An embodiment of the present disclosure further provides an electronic device, including a memory, a processor, and a computer program stored in the memory and executable on the processor, where the processor, when executing the program, implements one or more methods described in the embodiments of the present disclosure.

An embodiment of the present disclosure further provides a computer-readable storage medium, on which a computer program is stored, where the computer program, when executed by a processor, implements one or more methods described in the embodiments of the present disclosure.

Additional aspects and advantages of the embodiments of the present disclosure will be partially provided in the description below, which will become apparent from the description below, or will be learned through the practice of the present disclosure.

### BRIEF DESCRIPTION OF THE DRAWINGS

In order to more clearly illustrate the technical solutions of the embodiments of the present disclosure, the accompanying drawings that are to be used in the description of the embodiments of the present disclosure will be briefly introduced below. Obviously, the drawings in the following description are only some embodiments of the present disclosure, and those of ordinary skill in the art may obtain other drawings based on these drawings without paying creative effort.

FIG. 1 is a first flow chart of a communication method provided by an embodiment of the present disclosure;

FIG. 2 is a schematic diagram of a first example of an embodiment of the present disclosure;

FIG. 3 is a schematic diagram of a second example of an embodiment of the present disclosure;

FIG. 4 is a schematic diagram of a third example of an embodiment of the present disclosure;

FIG. 5 is a schematic diagram of a fourth example of an embodiment of the present disclosure;

FIG. 6 is a second flow chart of a communication method provided by an embodiment of the present disclosure;

FIG. 7 is a first schematic structural diagram of an electronic device provided by an embodiment of the present disclosure;

FIG. 8 is a second schematic structural diagram of an electronic device provided by an embodiment of the present disclosure; and

FIG. 9 is a third schematic structural diagram of an electronic device provided by an embodiment of the present disclosure.

### DETAILED DESCRIPTION

Exemplary embodiments are described in detail herein, examples of which are represented in the accompanying drawings. When the following description relates to the drawings, the same numerals in different accompanying drawings represent the same or similar elements unless otherwise indicated. The implementations described in the following exemplary embodiments do not represent all implementations consistent with the embodiments of the present disclosure. To the contrary, they are merely examples of apparatuses and methods that are consistent with some aspects of the embodiments of the present disclosure.

Terms used in the embodiments of the present disclosure are used solely for the purpose of describing certain embodiments and are not intended to limit the embodiments of the present disclosure. The singular forms of “a/an”, “said” and “the” used in the embodiments of the present disclosure are also intended to include plural forms unless the context clearly indicates other meanings. It should also be understood that the term “and/or” used herein refers to and includes any or all possible combinations of one or more associated listed items. For example, A and/or B can represent: A exists alone, A and B exist at the same time, and B exists alone. The character “/” generally indicates that the objects associated before and after are in an “or” relationship. The term “plurality” refers to two or more. In view of this, the term “plurality” can also be understood as “at least two” in the embodiments of the present disclosure.

It should be understood that although the terms first, second, third, etc. may be used to describe various information in the embodiments of the present disclosure, and such information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word as used herein may be interpreted as “when . . . ” or “while . . . ” or “in response to determination”.

The technical solutions in the embodiments of the present disclosure are clearly and completely described below with reference to the accompanying drawings in the embodiments of the present disclosure. Obviously, the described embodiments are only a part of the embodiments of the present disclosure, and not all of them. Based on the embodiments in the present disclosure, all other embodiments obtained by those of ordinary skill in the art without making creative efforts shall fall within the protection scope of the present disclosure.

Embodiments of the present disclosure provide a communication method, an electronic device, and a storage medium, for providing a mechanism for supporting STA switching between multiple APs.

The method and the apparatus are based on the same application concept. Since the principles of the method and the apparatus for solving problems are similar, the implementations of the apparatus and the method may refer to each other, and the repeated parts will not be described again.

As shown in FIG. 1, an embodiment of the present disclosure provides a communication method. In some examples, the method may be applied to a station (Station, STA). In some examples, in the embodiment of the present disclosure, the STA, for example, an electronic device with wireless network access functionality, provides a frame delivery service to enable information transmission. The access point (AP) device, for example, a device with wireless-to-wired bridging functionality, is responsible for extending the services provided by the wired network to the wireless network.

The method may include the following steps.

In step 101, a first data frame is determined, where the first data frame includes first identification information, the first identification information identifies that the STA requests to switch from a first access point (AP) to a second AP; the first identification information includes first switching parameter information for switching to the second AP.

In step 102, the first data frame is sent.

In UHR, low-latency service transmission mechanisms will be further enhanced. In the process of a STA transmitting low-latency services, a scenario where the STA switches between APs may also occur. It can be understood that, in the embodiments of the present disclosure, the AP may be an AP MLD. For the convenience of illustration, the following embodiments of the present disclosure are described using the AP as an example; however, this does not constitute a limitation on the embodiments of the present disclosure.

In order to meet the latency requirements of low-latency services in UHR, a STA may switch between multiple APs. For example, when the STA's location changes while the STA is communicating with AP1 for low-latency services, or when conducting low-latency service communication through the management of AP1 (e.g., Tunneled Direct Link Setup service), it needs to switch to AP2 to continue the low-latency service transmission. Alternatively, when the STA is communicating with AP1 and roams from the coverage of AP1 to the coverage of AP2, the communication link quality with AP1 deteriorates, then the STA seamlessly switches to AP2 for data communication, thereby ensuring uninterrupted data transmission.

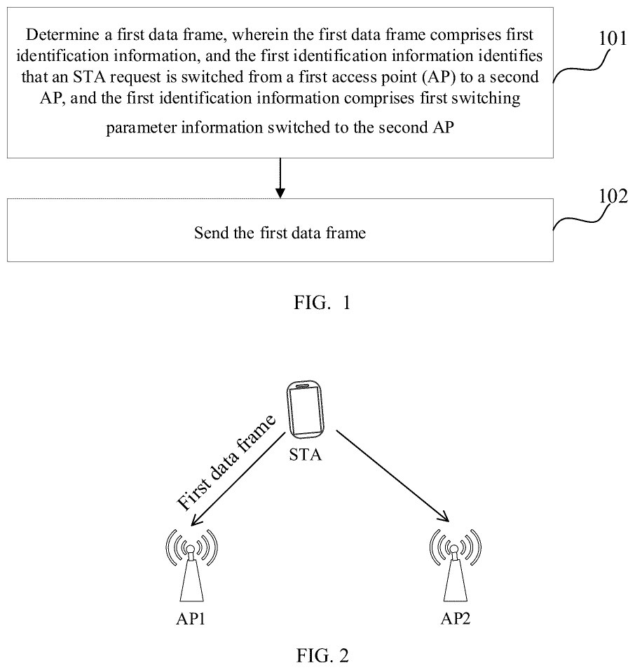

To achieve seamless data handover, in an embodiment of the present disclosure, a STA determines a first data frame, where first identification information in the first data frame identifies that the STA requests to switch from a first access point (AP) device to a second AP. The first data frame may be a data frame sent by the STA to the first AP for transmitting service data. As a first example, referring to FIG. 2, the STA determines a first data frame, which carries first identification information and is sent to the first AP (AP1). The first identification information includes first switching parameter information for switching to the second AP (AP2), so that in a scenario where the STA needs to switch to the second AP, it switches to the second AP according to the first switching parameter information.

It can be understood that the switching operation of the STA switching to the second AP may be initiated by the STA, for example, the STA directly sends the first data frame to the first AP; the switching operation may also be initiated by the first AP, for example, the first AP requests the STA to switch to the second AP through other wireless frames, then the STA determines and sends the first data frame, and executes subsequent processes.

In some examples, the first AP may be an AP with which the STA is currently communicating, and there may be multiple second Aps. The second AP and the first AP do not belong to the same AP MLD.

In the embodiment of the present disclosure, the STA determines a first data frame, where the first data frame carries first identity information. The first identification information identifies that the STA requests to switch from a first access point (AP) to a second AP. The first identification information includes first switching parameter information for switching to the second AP, so that when the communication status of the AP associated with the STA changes, the STA can switch to another AP for communication, thereby ensuring uninterrupted data transmission to meet the UHR's requirements for transmission rate and the requirements of low-latency services for latency.

An embodiment of the present disclosure provides a communication method. In some examples, the method may be applied to a station. The method may include the following steps:
determining a first data frame, where the first data frame includes first identification information, the first identification information identifies that the STA requests to switch from a first access point (AP) to a second AP, and the first identification information includes first switching parameter information for switching to the second AP; and
sending the first data frame.

The first switching parameter information includes at least one of the following parameters 1 to 4.
Parameter 1: The Link ID of the target link between the STA and the second AP, that is, the information of the link established between the STA and the second AP.
Parameter 2: The link existence identifier of the target link (Link bitmap) of the target link. For example, when there are multiple links between the STA and the second AP, the Link bitmap corresponding to each link indicates whether the STA requests to switch to the link. For example, if the bit corresponding to the link in the Link bitmap is set to “1”, it identifies that the STA requests to switch to that link.
Parameter 3: Media Access Control (MAC) address information of the second AP.
Parameter 4: MAC address information of the AP MLD to which the second AP is affiliated.

As an example, the frame structure format of the first switching parameter information may be as shown in the following Table 1:

TABLE 1

| | |
|---|---|
| Link ID | AP MAC address/AP MLD MAC address |

Or as shown in Table 2 below:

TABLE 2

| | |
|---|---|
| Link bitmap | AP MAC address/AP MLD MAC address |

An embodiment of the present disclosure provides a communication method. In some examples, the method may be applied to a station. The method may include the following steps:
determining a first data frame, where the first data frame includes first identification information, the first identification information identifies that the STA requests to switch from a first access point (AP) to a second AP, and the first identification information includes first switching parameter information for switching to the second AP; and
sending the first data frame.

The first switching parameter information also includes an immediate switching parameter (Immediate switching), which identifies whether the STA switches to the second AP immediately. For example, if the immediate switching parameter is set to “1,” it identifies that the STA switches to the second AP immediately. If the immediate switching parameter is set to “0,” it identifies that the STA does not switch to the second AP immediately. As an example, the frame structure format of the first switching parameter information may be as shown in Table 3 below:

TABLE 3

| | | |
|---|---|---|
| Link bitmap | AP MAC address/AP MLD MAC | Immediate switching |
| | address | |

As shown in Tables 1 to 3, the first switching parameter information includes the MAC address of the second AP, or the MAC address of the AP MLD to which the second AP belongs. In the latter case, the first AP and the second AP do not belong to the same physical entity, for example, do not belong to the same AP MLD.

An embodiment of the present disclosure provides a communication method. In some examples, the method may be applied to a station. The method may include the following steps:
determining a first data frame, where the first data frame includes first identification information, the first identification information identifies that the STA requests to switch from a first access point (AP) to a second AP, and the first identification information includes first switching parameter information for switching to the second AP; and
sending the first data frame.

The first switching parameter information further includes a duration parameter (Time duration), which identifies that the STA switches to the second AP after the time indicated by the duration parameter. For example, if the duration parameter is set to 5 milliseconds (ms), it identifies that the STA switches to the second AP in 5 milliseconds after the current moment.

In addition, the duration parameter may exist independently in the first switching parameter information, or may exist together with the immediate switching parameter in the first switching parameter information. For example, if the immediate switching parameter is set to 0, it identifies that the STA does not immediately switch to the second AP, but switches to the second AP after the time indicated by the duration parameter. As an example, the frame structure format of the first switching parameter information may be as shown in Table 4 below:

TABLE 4

| | | | |
|---|---|---|---|
| Link | AP MAC address/AP | Immediate | Time |
| bitmap | MLD MAC address | switching | duration |

An embodiment of the present disclosure provides a communication method. In some examples, the method may be applied to a station. The method may include the following steps:
determining a first data frame, where the first data frame includes first identification information, the first identification information identifies that the STA requests to switch from a first access point (AP) to a second AP; the first identification information includes first switching parameter information for switching to the second AP; and
sending the first data frame.

The first switching parameter information also includes a switching delay parameter (link transition delay), which indicates the delay generated by the STA during switching. For example, before switching, the STA negotiates a link transition delay with the first AP. The link transition delay may be in microseconds, such as 8 microseconds, 16 μs, etc.

An embodiment of the present disclosure provides a communication method. In some examples, the method may be applied to a station. The method may include the following steps:
determining a first data frame, where the first data frame includes first identification information, the first identification information identifies that the STA requests to switch from a first access point (AP) to a second (AP), and the first identification information includes first switching parameter information for switching to the second AP; and
sending the first data frame.

The first identification information is carried in an MAC frame header of the first data frame. For example, the frame structure format of the first switching parameter information shown in Tables 1 to 4 above may be carried in the MAC frame header of the first data frame.

An embodiment of the present disclosure provides a communication method. In some examples, the method may be applied to a station. The method may include the following steps:
determining a first data frame, where the first data frame includes first identification information, the first identification information identifies that the STA requests to switch from a first access point (AP) to a second AP, and the first identification information includes first switching parameter information for switching to the second AP;
sending the first data frame; and
receiving a first acknowledgment message frame sent by the first AP, and obtaining second identification information included in the first acknowledgment message frame, where the second identification information instructs the STA to switch to the second AP according to second switching parameter information carried in the second identification information.

Before the STA switches to the second AP, it may switch after receiving a first acknowledgment message (e.g., ACK) frame sent by the first AP. Furthermore, the first acknowledgment message frame includes second identification information, which includes second switching parameter information for the STA to switch to the second AP. The second switching parameter information is switching parameter information indicated by the first AP and specifically includes parameters 1 to 4, as well as the various parameters included in the first switching parameter information in the aforementioned embodiments. The format thereof refers to the format of the aforementioned parameters 1 to 4 and will not be repeated herein. In addition, the second switching parameter information further includes switching time point information.

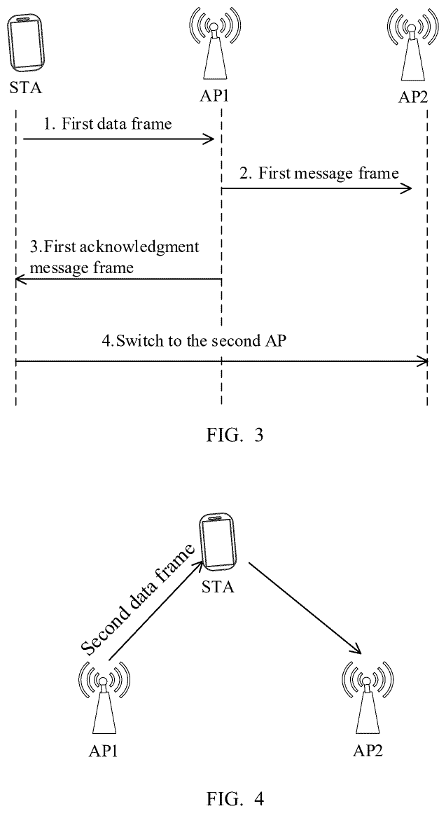

As a second example, referring to FIG. 3, FIG. 3 shows an application process of the communication method provided by an embodiment of the present disclosure, which mainly includes the following steps.
1. The STA determines and sends a first data frame, where the first data frame carries first identification information.
2. The first AP (AP1) sends a first message frame to the second AP (AP2), identifying that the STA will switch to AP2 for data communication;
3. AP1 sends a first acknowledgment message frame to the STA, where the first acknowledgment message frame includes second identification information, and the second identification information includes second switching parameter information for the STA to switch to the second AP;
4. STA switches from the AP1 to the AP2 and continues data communication, thereby ensuring uninterrupted data transmission.

An embodiment of the present disclosure provides a communication method. In some examples, the method may be applied to a station. The method may include the following steps:
receiving a second data frame, where the second data frame includes third identification information, the third identification information identifies that the first AP requests the STA to switch from the first AP to the second AP, and the third identification information includes third switching parameter information for switching to the second AP.

The second data frame may be a data frame sent by the first AP to the STA for transmitting service data, i.e., a downlink (DL) data frame. As a third example, referring to FIG. 4, the first AP (AP1) determines a second data frame and sends the second data frame carrying third identification information to the STA. The third identification information includes third switching parameter information for the STA to switch to the second AP (AP2). This allows the STA, in scenarios where a switch to the second AP is needed, to switch to the second AP according to the third switching parameter information.

It can be understood that the switching operation from the STA to the second AP may be initiated by the first AP, for example, the first AP directly sends the second data frame to the STA; the switching operation may also be initiated by the STA, for example, the STA requests the first AP to switch to the second AP through other wireless frames, then the first AP determines and sends the second data frame, and executes subsequent processes.

In some examples, the first AP may be an AP with which the STA is currently communicating, and there may be multiple second Aps. The second AP and the first AP do not belong to the same AP MLD.

The third switching parameter information includes switching parameter information, specifically including parameters 1 to 4, and the various parameters included in the first switching parameter information in the aforementioned embodiments. The format thereof refers to the format of the aforementioned parameters 1 to 4 and will not be repeated here.

An embodiment of the present disclosure provides a communication method. In some examples, the method may be applied to a station. The method may include the following steps:
receiving a second data frame, where the second data frame includes third identification information, the third identification information identifies that the first AP requests the STA to switch from the first AP to the second AP, and the third identification information includes third switching parameter information for switching to the second AP; and
sending a second acknowledgment message frame to the first AP, where the second acknowledgment message frame carries fourth identification information, and the fourth identification information identifies that the STA switches to the second AP according to the fourth switching parameter information carried in the fourth identification information.

Before the STA switches to the second AP, it sends a second acknowledgment message (e.g., ACK) frame to the first AP before switching. Furthermore, the second acknowledgment message frame includes fourth identification information, which includes fourth switching parameter information for the STA switching to the second AP. The fourth switching parameter information is the switching parameter information of the STA, which specifically includes parameters 1 to 4, as well as the various parameters included in the first switching parameter information in the aforementioned embodiments. The format thereof refers to the format of the aforementioned parameters 1 to 4 and will not be repeated herein. In addition, the fourth switching parameter information further includes information about the switching time point.

An embodiment of the present disclosure provides a communication method. In some examples, the method may be applied to a station. The method may include the following steps:
receiving a second data frame, where the second data frame includes third identification information, the third identification information identifies that the first AP requests the STA to switch from the first AP to the second AP, and the third identification information includes third switching parameter information for switching to the second AP;
sending a second acknowledgment message frame to the first AP, where the second acknowledgment message frame carries fourth identification information, and the fourth identification information identifies that the STA switches to the second AP according to the fourth switching parameter information carried in the fourth identification information; and
sending a first message frame to the second AP, where the first message frame identifies that the STA switches to the second AP.

Before replying the second acknowledgment message frame, the STA sends a first message frame to the second AP, identifying that the STA will switch to AP2 for data communication.

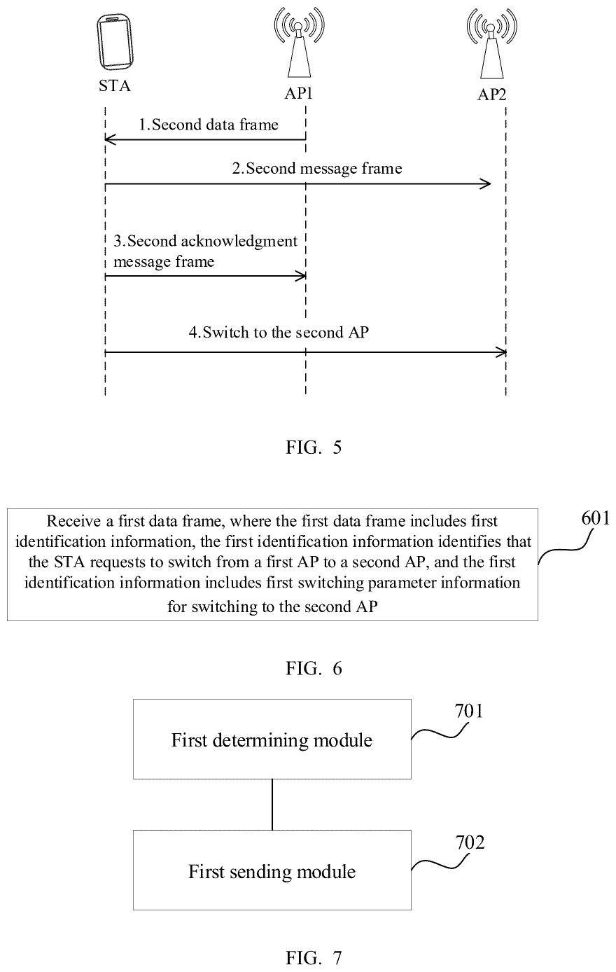

As a fourth example, referring to FIG. 5, FIG. 5 shows an application process of the communication method provided by an embodiment of the present disclosure, which mainly includes the following steps.
1. A first AP (AP1) determines and sends a second data frame, where the second data frame carries third identification information.
2. The STA sends a second message frame to the second AP (AP2), identifying that the STA will switch to AP2 for data communication.
3. The STA sends a second acknowledgment message frame to AP1, where the second acknowledgment message frame includes fourth identification information, and the fourth identification information includes fourth switching parameter information for the STA to switch to the second AP.
4. STA switches from AP1 to AP2 and continues data communication, thereby ensuring uninterrupted data transmission.

An embodiment of the present disclosure provides a communication method. In some examples, the method may be applied to a station. The method may include the following steps:
determining a first data frame, where the first data frame includes first identification information, the first identification information identifies that the STA requests to switch from the first access point AP to the second AP, and the first identification information includes first switching parameter information for switching to the second AP; and
sending the first data frame.

In some examples, the first switching parameter information includes at least one of the following:
a link identifier of a target link between the STA and the second AP;
a link existence identifier of the target link;
MAC address information of the second AP; and
MAC address information of the AP MLD to which the second AP is affiliated.

In some examples, the first switching parameter information further includes an immediate switching parameter, and the immediate switching parameter identifies whether the STA switches to the second AP immediately.

In some examples, the first switching parameter information further includes a duration parameter, and the duration parameter identifies that the STA switches to the second AP after a time indicated by the duration parameter.

In some examples, the first switching parameter information further includes a switching delay parameter, and the switching delay parameter indicates that the STA generates a time delay as specified by the switching delay parameter during switching.

Optionally, the first identification information is carried in a MAC frame header of the first data frame.

In some examples, after sending the first data frame, the method further includes:
receiving a first acknowledgment message frame sent by the first AP, and obtaining second identification information included in the first acknowledgment message frame, where the second identification information instructs the STA to switch to the second AP according to second switching parameter information carried in the second identification information.

In some examples, the method further includes:
receiving a second data frame, where the second data frame includes third identification information, the third identification information identifies that the first AP requests the STA to switch from the first AP to the second AP, and the third identification information includes third switching parameter information for switching to the second AP.

In some examples, after receiving the second data frame, the method further includes:
sending a second acknowledgment message frame to the first AP, where the second acknowledgment message frame carries fourth identification information, and the fourth identification information identifies that the STA switches to the second AP according to fourth switching parameter information carried in the fourth identification information.

In some examples, before sending the second acknowledgment message frame to the first AP, the method further includes:
sending a first message frame to the second AP, where the first message frame identifies that the STA switches to the second AP.

In the embodiments of the present disclosure, the STA determines a first data frame and carries first identification information in the first data frame. The first identification information identifies that the STA requests to switch from a first access point (AP) to a second AP, and the first identification information includes first switching parameter information for switching to the second AP, so that when the communication status of the AP associated with the STA changes, the STA can switch to another AP for communication, thereby ensuring uninterrupted data transmission and meeting the UHR's requirements for transmission rate and the requirements of low-latency services for latency.

Referring to FIG. 6, an embodiment of the present disclosure provides a communication method. In some examples, the method may be applied to a first access point (AP). The method may include the following steps.

In step 601, a first data frame is received, where the first data frame includes first identification information, the first identification information identifies that the STA requests to switch from a first AP to a second AP, and the first identification information includes first switching parameter information for switching to the second AP.

In UHR, low-latency service transmission mechanisms will be further enhanced. In the process of a STA transmitting low-latency services, a scenario where the STA switches between APs may also occur. It can be understood that, in the embodiments of the present disclosure, the AP may be an AP MLD. For the convenience of illustration, the following embodiments of the present disclosure are described using the AP as an example; however, this does not constitute a limitation on the embodiments of the present disclosure.

In order to meet the latency requirements of low-latency services in UHR, a STA may switch between multiple APs. For example, when the STA's location changes while the STA is communicating with AP1 for low-latency services, or when conducting low-latency service communication through the management of AP1 (e.g., Tunneled Direct Link Setup service), it needs to switch to AP2 to continue the low-latency service transmission. Alternatively, when the STA is communicating with AP1 and roams from the coverage of AP1 to the coverage of AP2, the communication link quality with AP1 deteriorates, then the STA seamlessly switches to AP2 for data communication, thereby ensuring uninterrupted data transmission.

In order to achieve seamless data switch, in an embodiment of the present disclosure, a first AP receives a first data frame, obtains first identification information in the first data frame, where the first identification information identifies that the STA requests to switch from the first access point AP to a second AP. The first data frame may be a data frame sent by the STA to the first AP for transmitting service data. As a first example, referring to FIG. 2, the STA determines a first data frame, carries first identification information in the first data frame, and sends it to a first AP (AP1). The first identification information includes first switch parameter information for switching to a second AP (AP2), so that in a scenario where the STA needs to switch to the second AP, the STA switches to the second AP according to the first switch parameter information.

It can be understood that the switching operation of the STA switching to the second AP may be initiated by the STA, for example, the STA directly sends the first data frame to the first AP; the switching operation may also be initiated by the first AP, for example, the first AP requests the STA to switch to the second AP through other wireless frames, then the STA determines and sends the first data frame, and executes subsequent processes.

In some examples, the first AP may be an AP with which the STA is currently communicating, and there may be multiple second Aps. The second AP and the first AP do not belong to the same AP MLD.

In embodiment of the present disclosure, a first AP receives a first data frame and obtains the first identification information in the first data frame, where the first identification information identifies that the STA requests to switch from the first access point (AP) to the second AP. The first identification information includes first switching parameter information for switching to the second AP, so that when the communication status of the AP associated with the STA changes, the STA can switch to another AP for communication, thereby ensuring uninterrupted data transmission to meet the UHR's requirements for transmission rate and the requirements of low-latency service for latency.

An embodiment of the present disclosure provides a communication method. In some examples, the method may be applied to a first access point (AP). The method may include the following steps:
receiving a first data frame, where the first data frame includes first identification information, the first identification information identifies that the STA requests to switch from the first AP to a second AP, and the first identification information includes first switching parameter information for switching to the second AP; and
sending a first acknowledgment message frame to the STA, where second identification information is included in the first acknowledgment message frame, and the second identification information instructs the STA to switch to the second AP according to second switching parameter information carried in the second identification information.

Before the STA switches to the second AP, the first AP sends a first acknowledgement message (e.g., ACK) frame to the STA. Furthermore, the first acknowledgement message frame includes second identification information, where the second identification information includes second switch parameter information for the STA to switch to the second AP. The second switch parameter information is the switch parameter information indicated by the first AP, and specifically includes parameter 1 to parameter 4, as well as the various parameters included in the first switch parameter information in the foregoing embodiments. The format thereof refers to the format of the aforementioned parameter 1 to parameter 4, which will not be repeated herein. In addition, the second switch parameter information further includes switching time point information.

An embodiment of the present disclosure provides a communication method. In some examples, the method may be applied to a first access point (AP). The method may include the following steps:
receiving a first data frame, where the first data frame includes first identification information, the first identification information identifies that the STA requests to switch from the first AP to a second AP, and the first identification information includes first switching parameter information for switching to the second AP;
sending a second message frame to the second AP, where the second message frame identifies that the STA switches to the second AP; and
sending a first acknowledgment message frame to the STA, where second identification information is included in the first acknowledgment message frame, and the second identification information instructs the STA to switch to the second AP according to second switching parameter information carried in the second identification information.

Before replying to the first acknowledgment message frame, the first AP sends a second message frame to the second AP, identifying that the STA will switch to AP2 for data communication.

In addition, the application process of the communication method provided by the embodiment of the present disclosure refers to the aforementioned third example and will not be repeated here.

An embodiment of the present disclosure provides a communication method. In some examples, the method may be applied to a first access point (AP). The method may include the following steps:
determining a second data frame, where the second data frame includes third identification information, the third identification information identifies that the first AP requests the STA to switch from the first AP to the second AP, and the third identification information includes third switching parameter information for switching to the second AP; and
sending the second data frame.

The second data frame may be a data frame sent by the first AP to the STA for transmitting service data, i.e., a downlink (DL) data frame. As a third example, referring to FIG. 4, the first AP (AP1) determines a second data frame and sends the second data frame carrying third identification information to the STA. The third identification information includes third switching parameter information for the STA to switch to the second AP (AP2). This allows the STA, in scenarios where a switch to the second AP is needed, to switch to the second AP according to the third switching parameter information.

It can be understood that the switching operation from the STA to the second AP may be initiated by the first AP, for example, the first AP directly sends the second data frame to the STA; the switching operation may also be initiated by the STA, for example, the STA requests the first AP to switch to the second AP through other wireless frames, then the first AP determines and sends the second data frame, and executes subsequent processes.

In some examples, the first AP may be an AP with which the STA is currently communicating, and there may be multiple second Aps. The second AP and the first AP do not belong to the same AP MLD.

The third switching parameter information includes switching parameter information, specifically including parameters 1 to 4, and the various parameters included in the first switching parameter information in the aforementioned embodiments. The format thereof refers to the format of the aforementioned parameters 1 to 4 and will not be repeated here.

An embodiment of the present disclosure provides a communication method. In some examples, the method may be applied to a first access point (AP). The method may include the following steps:
determining a second data frame, where the second data frame includes third identification information, the third identification information identifies that the first AP requests the STA to switch from the first AP to the second AP, and the third identification information includes third switching parameter information for switching to the second AP; and
sending the second data frame.

The third switching parameter information includes at least one of the following parameters 1 to 4.
Parameter 1: The Link ID of the target link between the STA and the second AP, that is, the information of the link established between the STA and the second AP.
Parameter 2: The link existence identifier of the target link (Link bitmap) of the target link. For example, when there are multiple links between the STA and the second AP, the Link bitmap corresponding to each link indicates whether the STA requests to switch to the link. For example, if the bit corresponding to the link in the Link bitmap is set to “1”, it identifies that the STA requests to switch to that link.
Parameter 3: Media Access Control (MAC) address information of the second AP.
Parameter 4: MAC address information of the AP MLD to which the second AP is affiliated.

As an example, the frame structure format of the third switching parameter information may be as shown in Table 1 and Table 2 above, which will not be described in detail here.

An embodiment of the present disclosure provides a communication method. In some examples, the method may be applied to a first access point (AP). The method may include the following steps.

A second data frame is determined, where the second data frame includes third identification information, the third identification information identifies that the first AP requests the STA to switch from the first AP to the second AP, and the first identification information comprises third switching parameter information for switching to the second AP.

The third switching parameter information further includes an immediate switching parameter, and the immediate switching parameter identifies whether the STA is to be immediately switched to the second AP.

The second data frame is sent.

The second switching parameter information also includes an immediate switching parameter (Immediate switching), which identifies whether the STA switches to the second AP immediately. For example, if the immediate switching parameter is set to 1, it identifies that the STA switches to the second AP immediately; if the immediate switching parameter is set to 0, it identifies that the STA does not switch to the second AP immediately. As an example, the frame structure format of the second switching parameter information may be as shown in Table 3 above, which is not further described here.

An embodiment of the present disclosure provides a communication method. In some examples, the method may be applied to a first access point (AP). The method may include the following steps.

A second data frame is determined, where the second data frame includes third identification information, the third identification information identifies that the first AP requests the STA to switch from the first AP to the second AP, and the third identification information includes third switching parameter information for switching to the second AP.

The second data frame is sent. The third switching parameter information further includes a duration parameter, where the duration parameter identifies that the STA switches to the second AP after a time indicated by the duration parameter.

An embodiment of the present disclosure provides a communication method. In some examples, the method may be applied to a first access point (AP). The method may include the following steps:
determining a second data frame, where the second data frame includes third identification information, the third identification information identifies that the first AP requests the STA to switch from the first AP to the second AP, and the third identification information includes third switching parameter information for switching to the second AP; and
sending the second data frame.

The third switching parameter information further includes a switching delay parameter, and the switching delay parameter indicates that the STA generates a time delay as specified by the switching delay parameter during switching.

The third switching parameter information also includes a switching delay parameter (link transition delay), which indicates a delay generated by the STA during switching. For example, the link transition delay negotiated between the STA and the first AP before switching may be in microseconds, such as 8 microseconds (μs) or 16 microseconds.

An embodiment of the present disclosure provides a communication method. In some examples, the method may be applied to a first access point (AP). The method may include the following steps:
determining a second data frame, where the second data frame includes third identification information, the third identification information identifies that the first AP requests the STA to switch from the first AP to the second AP, and the third identification information includes third switching parameter information for switching to the second AP; and
sending the second data frame, where third identification information is carried in a MAC frame header of the second data frame.

The third identification information is carried in the MAC frame header of the second data frame. For example, the frame structure format of the third switching parameter information shown in Tables 1 to 4 above may be carried in the MAC frame header of the second data frame.

An embodiment of the present disclosure provides a communication method. In some examples, the method may be applied to a first access point (AP). The method may include the following steps:
determining a second data frame, where the second data frame includes third identification information, the third identification information identifies that the first AP requests the STA to switch from the first AP to the second AP, and the third identification information includes third switching parameter information for switching to the second AP;
sending the second data frame; and
receiving a second acknowledgment message frame sent by the STA, where fourth identification information is carried in the second acknowledgment message frame, and the fourth identification information identifies that the STA switches to the second AP according to fourth switching parameter information carried in the fourth identification information.

Before the STA switches to the second AP, it sends a second acknowledgment message (e.g., ACK) frame to the first AP before switching. Furthermore, the second acknowledgment message frame includes fourth identification information, which includes fourth switching parameter information for the STA switching to the second AP. The fourth switching parameter information is the switching parameter information of the STA, which specifically includes parameters 1 to 4, as well as the various parameters included in the first switching parameter information in the aforementioned embodiments. The format thereof refers to the format of the aforementioned parameters 1 to 4 and will not be repeated herein. In addition, the fourth switching parameter information further includes information about the switching time point.

In addition, the application process of the communication method provided by the embodiment of the present disclosure refers to the aforementioned fourth example and will not be repeated here.

An embodiment of the present disclosure provides a communication method. In some examples, the method may be applied to a first access point (AP). The method may include the following steps:
receiving a first data frame, where the first data frame includes first identification information, the first identification information identifies that the STA requests to switch from the first AP to a second AP, and the first identification information includes first switching parameter information for switching to the second AP.

In some examples, after receiving the first data frame, the method further includes:
sending a first acknowledgment message frame to the STA, where second identification information is included in the first acknowledgment message frame, and the second identification information instructs the STA to switch to the second AP according to second switching parameter information carried in the second identification information.

In some examples, before sending the first acknowledgment message frame to the STA, the method further includes:
sending a second message frame to the second AP, where the second message frame identifies that the STA switches to the second AP.

In some examples, the method further includes:
determining a second data frame, where the second data frame comprises third identification information, the third identification information identifies that the first AP requests the STA to switch from the first AP to the second AP, and the third identification information comprises third switching parameter information for switching to the second AP; and
sending the second data frame.

In some examples, the third switching parameter information includes at least one of the following:
a link identifier of a target link between the STA and the second AP;
a link existence identifier of the target link;
MAC address information of the second AP; and
MAC address information of an AP MLD to which the second AP is affiliated.

In some examples, the third switching parameter information further includes an immediate switching parameter, and the immediate switching parameter identifies whether the STA switches to the second AP immediately.

In some examples, the third switching parameter information further includes a duration parameter, and the duration parameter identifies that the STA switches to the second AP after a time indicated by the duration parameter.

In some examples, the third switching parameter information further includes a switching delay parameter, and the switching delay parameter indicates that the STA generates a time delay as specified by the switching delay parameter during switching.

In some examples, the third identification information is carried in a MAC frame header of the second data frame.

In some examples, after sending the second data frame, the method further includes:
receiving a second acknowledgment message frame sent by the STA, where fourth identification information is carried in the second acknowledgment message frame, and the fourth identification information identifies that the STA switches to the second AP according to fourth switching parameter information carried in the fourth identification information.

In the embodiments of the present disclosure, a first AP receives a first data frame and obtains the first identification information in the first data frame, where the first identification information identifies that the STA requests to switch from the first access point (AP) to the second AP; the first identification information includes first switching parameter information for switching to the second AP, so that when the communication status of the AP associated with the STA changes, the STA can switch to another AP for communication, thereby ensuring uninterrupted data transmission to meet the UHR's requirements for transmission rate and the requirements of low-latency service for latency.

Referring to FIG. 7, based on the same principle as the method provided in the embodiment of the present disclosure, an embodiment of the present disclosure further provides an electronic device, the electronic device is a station (STA), and the electronic device includes:
a first determining module 701, configured to determine a first data frame, where the first data frame includes first identification information, the first identification information identifying that the STA requests to switch from the first access point (AP) to the second AP; and the first identification information includes first switching parameter information for switching to the second AP; and
a first sending module 702, configured to send the first data frame.

In some examples, the first switching parameter information includes at least one of the following:
a link identifier of a target link between the STA and the second AP;
a link existence identifier of the target link;
MAC address information of the second AP; and
MAC address information of an AP MLD to which the second AP is affiliated.

In some examples, the first switching parameter information further includes an immediate switching parameter, and the immediate switching parameter identifies whether the STA switches to the second AP immediately.

In some examples, the first switching parameter information further includes a duration parameter, where the duration parameter identifies that the STA switches to the second AP after a time indicated by the duration parameter.

In some examples, the first switching parameter information further includes a switching delay parameter, and the switching delay parameter indicates that the STA generates a time delay as specified by the switching delay parameter during switching.

In some examples, the first identification information is carried in a MAC frame header of the first data frame.

Optionally, the electronic device further includes:
a second receiving module, configured to receive a first acknowledgment message frame sent by the first AP, and obtain second identification information included in the first acknowledgment message frame, where the second identification information instructs the STA to switch to the second AP according to second switching parameter information carried in the second identification information.

In some examples, the electronic device further includes:
a third receiving module, configured to receive a second data frame, where the second data frame includes third identification information, and the third identification information identifies that the first AP requests the STA to switch from the first AP to the second AP, and the third identification information includes third switching parameter information for switching to the second AP.

In some examples, the electronic device further includes:
a second sending module, configured to send a second acknowledgment message frame to the first AP, where fourth identification information is carried in the second acknowledgment message frame, and the fourth identification information identifies that the STA switches to the second AP according to fourth switching parameter information carried in the fourth identification information.

In some examples, the electronic device further includes:
a third sending module, configured to send a first message frame to the second AP, where the first message frame identifies that the STA switches to the second AP.

The present disclosure also provides a communication apparatus, which is applied to a station (STA). The apparatus includes:
a first data frame determining module, configured to determine a first data frame, where the first data frame includes first identification information, the first identification information identifies that the STA requests to switch from the first access point (AP) to the second AP; and the first identification information includes first switching parameter information for switching to the second AP; and
a first data frame sending module, configured to send the first data frame.

The apparatus further includes other modules of the electronic device in the aforementioned embodiment, which will not be described in detail here.

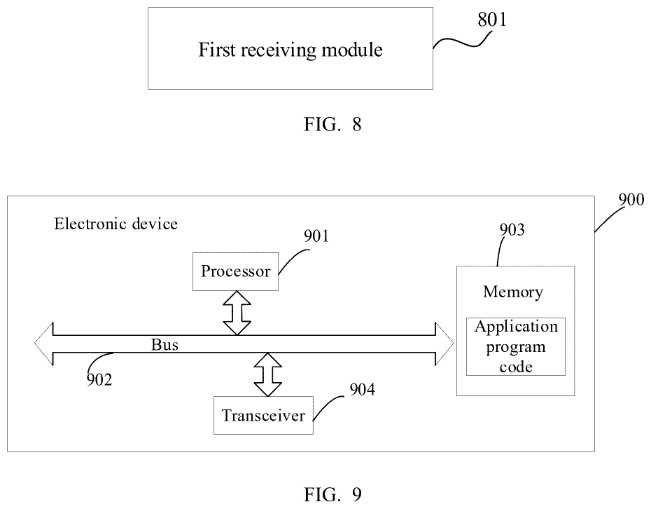

Referring to FIG. 8, based on the same principle as the method provided in the embodiment of the present disclosure, an embodiment of the present disclosure further provides an electronic device, the electronic device is a first access point (AP), and the electronic device includes:
a first receiving module 801, configured to receive a first data frame, where the first data frame includes first identification information, the first identification information identifies that an STA requests to switch from the first AP to a second AP, and the first identification information includes first switching parameter information for switching to the second AP.

In some examples, the electronic device further includes:
a fourth sending module, configured to send a first acknowledgment message frame to the STA, where second identification information is included in the first acknowledgment message frame, and the second identification information instructs the STA to switch to the second AP according to second switching parameter information carried in the second identification information.

In some examples, the electronic device further includes:
a fifth sending module, configured to send a second message frame to the second AP, where the second message frame identifies that the STA switches to the second AP.

In some examples, the electronic device further includes:
a second determining module, configured to determine a second data frame, where the second data frame includes third identification information, the third identification information identifies that the first AP requests the STA to switch from the first AP to the second AP, and the third identification information includes third switching parameter information for switching to the second AP; and
a sixth sending module, configured to send the second data frame.

In some examples, the third switching parameter information includes at least one of the following:
a link identifier of a target link between the STA and the second AP;
a link existence identifier of the target link;
MAC address information of the second AP; and
MAC address information of an AP MLD to which the second AP is affiliated.

In some examples, the third switching parameter information further includes an immediate switching parameter, and the immediate switching parameter identifies whether the STA switches to the second AP immediately.

In some examples, the third switching parameter information further includes a duration parameter, and the duration parameter identifies that the STA switches to the second AP after a time indicated by the duration parameter.

In some examples, the third switching parameter information further includes a switching delay parameter, and the switching delay parameter indicates that the STA generates a time delay as specified by the switching delay parameter during switching.

In some examples, the third identification information is carried in a MAC frame header of the second data frame.

In some examples, the electronic device further includes:
a fourth receiving module, configured to receive a second acknowledgment message frame sent by the STA, where fourth identification information is carried in the second acknowledgment message frame, and the fourth identification information identifies that the STA switches to the second AP according to fourth switching parameter information carried in the fourth identification information.

The present disclosure also provides a communication apparatus, which is applied to a first access point (AP). The apparatus includes:
a first data frame receiving module, configured to receive a first data frame; where the first data frame includes first identification information, the first identification information identifies that the STA requests to switch from the first AP to the second AP, and the first identification information includes first switching parameter information for switching to the second AP.

The apparatus further includes other modules of the electronic device in the aforementioned embodiments, which will not be described in detail herein.

In the embodiments of the present disclosure, the STA determines a first data frame and carries first identification information in the first data frame. The first identification information identifies that the STA requests to switch from a first access point (AP) to a second AP, and the first identification information includes first switching parameter information for switching to the second AP, so that when the communication status of the AP associated with the STA changes, the STA can switch to another AP for communication, thereby ensuring uninterrupted data transmission and meeting the UHR's requirements for transmission rate and the requirements of low-latency services for latency.

In an optional embodiment, an embodiment of the present disclosure further provides an electronic device. As shown in FIG. 9, the electronic device 900 shown in FIG. 9 may be a server, including: a processor 901 and a memory 903. The processor 901 is connected to the memory 903, for example, via a bus 902. In some examples, the electronic device 900 may further include a transceiver 904. It should be noted that, in practical applications, the number of transceivers 904 is not limited to one, and the structure of the electronic device 900 does not constitute a limitation on the embodiments of the present disclosure.

The processor 901 may be a central processing unit (CPU), a general-purpose processor, a digital signal processor (DSP), an application specific integrated circuit (ASIC), a field programmable gate array (FPGA), or other programmable logic devices, transistor logic devices, hardware components, or any combination thereof. It can implement or execute various exemplary logical blocks, modules, and circuits described with reference to the disclosure of the present disclosure. The processor 901 may also be a combination that implements computing functions, such as a combination including one or more microprocessors, a combination of a DSP and a microprocessor, etc.

The bus 902 may include a path for transmitting information between the above components. The bus 902 may be a peripheral component interconnect (PCI) bus or an extended industry standard architecture (EISA) bus, or the like. The bus 902 may be divided into an address bus, a data bus, a control bus, etc. For ease of representation, only one thick line is used in FIG. 9 for indicating the bus, but it does not indicate that there is only one bus or only one type of bus.

The memory 903 may be a read only memory (ROM) or other types of static storage devices that may store static information and instructions, a random access memory (RAM) or other types of dynamic storage devices that may store information and instructions, or an electrically erasable programmable read only memory (EEPROM), a compact disc read only memory (CD-ROM) or other optical disk storage, optical disc storage (including compact optical disc, laser disc, optical disc, digital versatile optical disc, Blu-ray disc, etc.), a magnetic disk storage medium or other magnetic storage device, or any other medium that may be used to carry or store desired program code in the form of instructions or data structures and may be accessed by a computer, but is not limited thereto.

The memory 903 is used to store the application program code for executing the solutions of the present disclosure, and the execution is controlled by the processor 901. The processor 901 is configured to execute the application program code stored in the memory 903, so as to implement the contents shown in the foregoing method embodiments.

The electronic device includes, but is not limited to: a mobile terminal such as a mobile phone, a laptop computer, a digital broadcast receiver, a personal digital assistant (PDA), a tablet computer (PAD), a portable multimedia player (PMP), a vehicle-mounted terminal (e.g., a vehicle-mounted navigation terminal), etc., as well a fixed terminal such as a digital TV, a desktop computer, and the like. The electronic device shown in FIG. 9 is merely an example and should not impose any limitation on the functions and scope of use of the embodiments of the present disclosure.

The server provided in the present disclosure may be an independent physical server, a server cluster or a distributed system composed of multiple physical servers, or a cloud server that provides basic cloud computing services such as cloud services, cloud databases, cloud computing, cloud functions, cloud storage, network services, cloud communications, middleware services, domain name services, security services, CDN, as well as big data and artificial intelligence platforms. The terminal may be a smart phone, a tablet computer, a notebook computer, a desktop computer, a smart speaker, a smart watch, etc., but is not limited thereto. The terminal and the server can be connected directly or indirectly through wired or wireless communication methods, which is not limited in the present disclosure.

An embodiment of the present disclosure provides a computer-readable storage medium on which a computer program is stored, the computer program, when being run on a computer, causes the computer to execute the corresponding contents in the above method embodiments.

It should be understood that, although the steps in the flowcharts of the accompanying drawings are shown in sequence as indicated by the arrows, these steps are not necessarily performed sequentially in the order as indicated by the arrows. There is no strict restriction on the performing order of these steps, and they may be performed in other orders, unless otherwise stated herein. Moreover, at least a part of the steps in the flowcharts of the accompanying drawings may include multiple sub-steps or multiple stages, and these sub-steps or stages are not necessarily completed at the same time, but may be performed at different times, and the performing order thereof is not necessarily sequential, but may be performed in turn or alternately with other steps or at least a part of the sub-steps or stages of other steps.

It should be noted that the computer-readable medium mentioned above in the present disclosure may be a computer-readable signal medium or a computer-readable storage medium or any combination of the two. The computer-readable storage medium may be, for example, but is not limited to, an electrical, magnetic, optical, electromagnetic, infrared, or semiconductor system, apparatus or device, or any combination of the above. More specific examples of the computer-readable storage medium may include, but is not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium containing or storing a program that may be used by or in combination with an instruction execution system, apparatus or device. In the present disclosure, the computer-readable signal medium may include a data signal propagated in a baseband or as part of a carrier wave, which carries computer-readable program code. The propagated data signal may take a variety of forms, including but not limited to electromagnetic signals, optical signals, or any suitable combination of the above. The computer readable signal medium may also be any computer readable medium other than the computer readable storage medium, which may send, propagate or transmit a program for use by or in conjunction with an instruction execution system, apparatus or device. The program code contained on the computer readable medium may be transmitted using any appropriate medium, including but not limited to: wires, optical cables, RF (radio frequency), etc., or any suitable combination of the above.

The aforementioned computer-readable medium may be included in the above-mentioned electronic device; alternatively, it may exist independently without being assembled into the electronic device.

The computer-readable medium carries one or more programs. The one or more programs, when executed by the electronic device, cause the electronic device to execute the method shown in the above embodiments.

According to an aspect of the present disclosure, a computer program product or a computer program is provided, the computer program product or the computer program includes computer instructions, and the computer instructions are stored in a computer-readable storage medium. A processor of a computer device reads the computer instructions from the computer-readable storage medium, and the processor executes the computer instructions, to cause the computer device to perform the methods provided in the above various optional implementations.

The computer program code for performing the operations of the present disclosure may be written in one or more programming languages, or a combination thereof, including object-oriented programming languages, such as Java, Smalltalk, C++, and conventional procedural programming languages, such as “C” language or similar programming languages. The program code may be executed entirely on the user's computer, partially executed on the user's computer, executed as a separate software package, executed partially on the user's computer and partially on a remote computer, or executed entirely on a remote computer or server. In the cases involving a remote computer, the remote computer may be connected to the user's computer through any type of network, including a local area network (LAN) or a wide area network (WAN), or may be connected to an external computer (e.g., via Internet using an Internet service provider).

The flow charts and block diagrams in the accompanying drawings illustrate the possible architectures, functions and operations of the system, method and computer program product according to various embodiments of the present disclosure. In this regard, each of the blocks in the flow charts or block diagrams may represent a module, a program segment or part of code, and the module, the program segment or the part of code contains one or more executable instructions for realizing the specified logical functions. It should also be noted that in some alternative implementations, the functions marked in the blocks may also occur in a sequence different from that marked in the accompanying drawings. For example, two blocks shown in succession may actually be executed substantially in parallel, or they may sometimes be executed in the opposite order, depending on the functions involved. It should also be noted that each block in the block diagrams and/or flow charts, and the combination of the blocks in the block diagrams and/or flow charts may be implemented with a dedicated hardware-based system that performs a specified function or operation, or may be implemented with a combination of dedicated hardware and computer instructions.

The modules involved in the embodiments described in the present disclosure may be implemented in software or in hardware. The names of the modules do not make limitation on the modules themselves in some cases. For example, a module A may also be described as “a module A for performing operation B”.

Those described above are only explanations of preferred embodiments of the present disclosure and the technical principles employed. Those skilled in the art should understand that the scope of disclosure involved in the present disclosure is not limited to the technical solutions formed by the above specific combination of the technical features, but should also cover other technical solutions formed by any combination of the above technical features or their equivalent features without departing from the above disclosed concept, for example, a technical solution formed by replacing the above features with the technical features with similar functions disclosed in the present disclosure (but not limited thereto).

1. A communication method, performed by a station (STA), comprising:
determining a first data frame, wherein the first data frame comprises first identification information, the first identification information indicates that the STA requests to switch from a first access point (AP) to a second AP, and the first identification information comprises first switching parameter information for switching to the second AP; and
sending the first data frame.

2. The communication method according to claim 1, wherein the first switching parameter information comprises at least one of:
a link identifier of the link between the STA and the second AP;
a link existence identifier of the link;
MAC address information of the second AP; or
MAC address information of an AP MLD to which the second AP is affiliated.

3. The communication method according to claim 1, wherein the first switching parameter information further comprises at least one of an immediate switching parameter or a duration parameter, wherein the immediate switching parameter indicates whether the STA switches to the second AP immediately, and the duration parameter identifies that the STA switches to the second AP after a time indicated by the duration parameter.

4. (canceled)

5. The communication method according to claim 1, wherein the first switching parameter information further comprises a switching delay parameter, and the switching delay parameter indicates that the STA generates a time delay as specified by the switching delay parameter during switching.

6. The communication method according to claim 1, wherein the first identification information is carried in a MAC frame header of the first data frame.

7. The communication method according to claim 1, wherein after sending the first data frame, the method further comprises:
receiving a first acknowledgment message frame sent by the first AP, and obtaining second identification information included in the first acknowledgment message frame, wherein the second identification information instructs the STA to switch to the second AP according to second switching parameter information carried in the second identification information.

8. The communication method according to claim 1, further comprising:
receiving a second data frame, wherein the second data frame comprises third identification information, the third identification information indicates that the first AP requests the STA to switch from the first AP to the second AP, and the third identification information comprises third switching parameter information for switching to the second AP.

9. The communication method according to claim 8, wherein after receiving the second data frame, the method further comprises:
sending a second acknowledgment message frame to the first AP, wherein fourth identification information is carried in the second acknowledgment message frame, and the fourth identification information indicates that the STA switches to the second AP according to fourth switching parameter information carried in the fourth identification information.

10. The communication method according to claim 9, wherein before sending the second acknowledgment message frame to the first AP, the method further comprises:
sending a first message frame to the second AP, wherein the first message frame indicates that the STA switches to the second AP.

11. A communication method, performed by a first access point (AP), comprising:
receiving a first data frame, wherein the first data frame comprises first identification information, the first identification information indicates that an STA requests to switch from the first AP to a second AP, and the first identification information comprises first switching parameter information for switching to the second AP.

12. The communication method according to claim 11, wherein after receiving the first data frame, the method further comprises:
sending a first acknowledgment message frame to the STA, wherein second identification information is included in the first acknowledgment message frame, and the second identification information instructs the STA to switch to the second AP according to second switching parameter information carried in the second identification information.

13. The communication method according to claim 12, wherein before sending the first acknowledgment message frame to the STA, the method further comprises:
sending a second message frame to the second AP, wherein the second message frame indicates that the STA switches to the second AP.

14. The communication method according to claim 11, further comprising:
determining a second data frame, wherein the second data frame comprises third identification information, the third identification information indicates that the first AP requests the STA to switch from the first AP to the second AP, and the third identification information comprises third switching parameter information for switching to the second AP; and
sending the second data frame.

15. The communication method according to claim 14, wherein the third switching parameter information comprises at least one of:
a link identifier of the link between the STA and the second AP;
a link existence identifier of the link;
MAC address information of the second AP; or
MAC address information of an AP MLD to which the second AP is affiliated.

16. The communication method according to claim 14, wherein the third switching parameter information further comprises at least one of an immediate switching parameter or a duration parameter, wherein the immediate switching parameter indicates whether the STA switches to the second AP immediately, and the duration parameter identifies that the STA switches to the second AP after a time indicated by the duration parameter.

17. (canceled)

18. The communication method according to claim 14, wherein the third switching parameter information further comprises a switching delay parameter, and the switching delay parameter indicates that the STA generates a time delay as specified by the switching delay parameter during switching.

19. The communication method according to claim 14, wherein the third identification information is carried in a MAC frame header of the second data frame.

20. The communication method according to claim 14, wherein after sending the second data frame, the method further comprises:
receiving a second acknowledgment message frame sent by the STA, wherein fourth identification information is carried in the second acknowledgment message frame, and the fourth identification information indicates that the STA switches to the second AP according to fourth switching parameter information carried in the fourth identification information.

21-22. (canceled)

23. An electronic device, comprising a memory, a processor and a computer program stored in the memory and executable on the processor, wherein the processor, when executing the program, is configured to:
determine a first data frame, wherein the first data frame comprises first identification information, the first identification information indicates that the electronic devices requests to switch from a first access point (AP) to a second AP, and the first identification information comprises first switching parameter information for switching to the second AP; and
send the first data frame.

24. (canceled)

25. An electronic device, comprising a memory, a processor and a computer program stored in the memory and executable on the processor, wherein the processor, when executing the program, implements the method according to claim 11.
